(19) United States
(12) Patent Application Publication
(10) Pub. No.: US 2025/0336622 A1
(43) Pub. Date: Oct. 30, 2025

(54) METHOD FOR ACTUATING AN ON-LOAD TAP-CHANGER, AND ON-LOAD TAP-CHANGER DEVICE

(71) Applicant: Maschinenfabrik Reinhausen GmbH, Regensburg (DE)

(72) Inventor: Andreas Sachsenhauser, Mallersdorf (DE)

(21) Appl. No.: 18/871,501

(22) PCT Filed: Jun. 20, 2023
(86) PCT No.: PCT/EP2023/066605

§ 371 Date: Dec. 4, 2024

(30) Foreign Application Priority Data
Jul. 14, 2022 (DE) 10 2022 117 587.1

(51) Int. Cl. H01H 9/56; H01H 9/00

(52) U.S. Cl. CPC H01H 9/56; H01H 9/0005; H01H 2009/0061

(57) ABSTRACT

A method for actuating an on-load tap-changer using a control device, a sensor, and a drive is provided. The control device receives a switching command for actuating the on-load tap-changer. The sensor detects a current profile. The control device determines multiple consecutive times for current zero crossings of the current profile and multiple intervals between the multiple consecutive times of the current zero crossings. The control device derives a characteristic variable from the multiple intervals and compares the characteristic variable with a limit value. The control device terminates or pauses the actuation based on determining that the characteristic variable exceeds the limit value and performs the actuation by controlling the drive based on determining that the characteristic variable satisfies or falls below the limit value.

### CROSS REFERENCE TO RELATED APPLICATIONS

This application is a U.S. National Phase application under 35 U.S.C. § 371 of International Application No. PCT/EP2023/066605, filed on Jun. 20, 2023, and claims benefit to German Patent Application No. DE 10 2022 117 587.1, filed on Jul. 14, 2022. The International Application was published in German on Jan. 18, 2024 as WO 2024/012813 A1 under PCT Article 21(2).

### FIELD

The invention relates to a method for actuating an on-load tap-changer and to an on-load tap-changer device.

### BACKGROUND

In substations, there are a large number of switches for different tasks and with different requirements. To operate the various switches, they may be driven via a drive system. These switches include, amongst others, on-load tap-changers, diverter switches, selectors, double reversing change-over selectors, reversing change-over selectors, change-over selectors, circuit breakers, on-load switches or disconnecting switches.

For example, on-load tap-changers are used for uninterrupted switchover between different winding taps of an item of electrical equipment, such as a power transformer. For example, this makes it possible for the transmission ratio of the transformer or the inductance of the reactor to be changed.

On-load tap-changers are usually actuated by means of a combination of a motor-drive unit and a spring energy accumulator. The actuation takes place immediately after the switching command, i.e. at any time. The occurrence of inrush is not taken into account here.

### SUMMARY

In an embodiment, the present disclosure provides a method for actuating an on-load tap-changer. The method includes a control device that receives a switching command for actuating the on-load tap-changer and a current profile being detected via a sensor. The control device determines multiple consecutive times for current zero crossings of the current profile and multiple intervals between the multiple consecutive times of the current zero crossings. The control device derives a characteristic variable from the multiple intervals and compares the characteristic variable with a limit value. The control device terminates or pauses the actuation based on determining that the characteristic variable exceeds the limit value, and performs the actuation by controlling a drive based on determining that the characteristic variable satisfies or falls below the limit value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a tap-changing transformer having an on-load tap-changer, according to an embodiment of the present disclosure;

FIG. 2 shows a method sequence, according to an embodiment of the present disclosure;

FIG. 3 shows a graph for explaining the method, according to an embodiment of the present disclosure; and

FIG. 4 shows a further graph of a further embodiment for explaining the method, according to an embodiment of the present disclosure.

### DETAILED DESCRIPTION

In accordance with an embodiment, the present disclosure provides a method for actuating an on-load tap-changer which ensures safe switchover.

The invention proposes a method for actuating an on-load tap-changer by means of a drive, a sensor and a control device, comprising the following steps:
the control device receiving a switching command for actuating the on-load tap-changer;
a current curve being detected via the sensor;
the control device determining multiple consecutive times for current zero crossings of the current profile;
the control device determining several intervals between the times of the current zero crossings;
the control device deriving a characteristic variable from the multiple intervals;
the control device comparing the characteristic variable with a limit value;
the control device terminating or pausing the actuation if the characteristic variable exceeds the limit value;
performing the actuation if the characteristic variable satisfies or falls below the limit value by the control device controlling the drive.

The method is based on the idea of monitoring the current profile within the tap-changing transformer, on-load tap-changer or vacuum interrupter before or after a switching command and detecting an occurring inrush before the actual actuation of the on-load tap-changer. The intervals between the current zero passages are then determined based on the current zero passages identified in the past or after the switching command. A characteristic value derived from said intervals is compared with a limit value. If the limit value is satisfied, an inrush can be ruled out, and so the actuation can be performed safely and reliably. However, if an inrush occurs before or after the switching command, the actuation is terminated or paused. In the context of the invention, inrush is understood to mean the occurrence of irregularities in the current profile.

After the switching command for actuating the on-load tap-changer is received by the control device, the actuation of the on-load tap-changer is not immediately started, but first the past current profile or the current profile after the switching command is checked for irregularities. The actual actuation is accordingly only performed when no irregularities have been identified.

The current profile may be detected in any manner. In particular, the current profile is detected via one or more sensors on the tap-changing transformer or on-load tap-changer and transmitted to the control device.

The detected current profile is processed and evaluated and multiple consecutive times in the current profile are determined in the control device. The times are current zero crossings. At least three consecutive times at which the current is zero are preferably determined. Furthermore, the starting time in the current profile is determined. Depending on the form, the past current profile is determined from the starting time or the future current profile is determined from the starting time. In this case, the past current profile is either already stored in the control device before the starting time or is stored after the starting time.

Furthermore, multiple intervals between the multiple consecutive times of the current zero crossings are determined by means of the control device. Two intervals are determined at three times. In particular, the interval between the first and second time and the interval between the second and third time are determined.

Furthermore, a characteristic variable is determined from the multiple intervals by means of the control device. The characteristic variable may be a ratio, a mean value, etc. The characteristic value is compared with a limit value by means of the control device. The limit value is stored in the control device. The limit value can be adjusted manually or automatically.

Furthermore, the actuation of the on-load tap-changer by controlling the drive is carried out by means of the control device if the characteristic variable satisfies or falls below the limit value. The actual actuation is paused or terminated if the characteristic value exceeds the limit value. For example, pausing or terminating the actuation may take several seconds, for example 1 to 10 seconds. After pausing, the current profile is detected again and the method is carried out again until actuation is possible.

Furthermore, the invention proposes an on-load tap-changer device comprising:
an on-load tap-changer;
a sensor;
a drive;
a control device;
   wherein
the control device is configured and designed
to receive a switching command to actuate the on-load tap-changer;
to detect a current profile via the sensor;
to determine multiple consecutive times for current zero crossings of the current profile;
to determine several intervals between the times of the current zero crossings;
to derive a characteristic variable from the multiple intervals;
to compare the characteristic variable with a limit value;
to terminate or pause the actuation by the control device if the characteristic variable exceeds the limit value;
to actuate the on-load tap-changer by means of the drive if the characteristic variable satisfies or falls below the limit value.

The on-load tap-changer device has an on-load tap-changer with a diverter switch and a selector. The diverter switch comprises at least one vacuum interrupter. Furthermore, the on-load tap-changer device comprises a drive, a sensor and a control device. The on-load tap-changer device enables the current profile to be checked before the on-load tap-changer is actuated, thus ensuring safe actuation in the event of an occurring inrush. The control device is configured and designed to continuously detect a current profile via a sensor or a plurality of sensors during the operation of the tap-changing transformer, that is to say to detect, store and process said current profile before a switching command. For this purpose, said control device accordingly comprises a computing unit and/or a processor and/or a memory. The control device is configured and designed to detect, store and process a current profile via a sensor or a plurality of sensors after a switching command. For this purpose, said control device accordingly comprises a computing unit and/or a processor and/or a memory.

Furthermore, the control device is configured and designed to control the drive, which in turn actuates the on-load tap-changer.

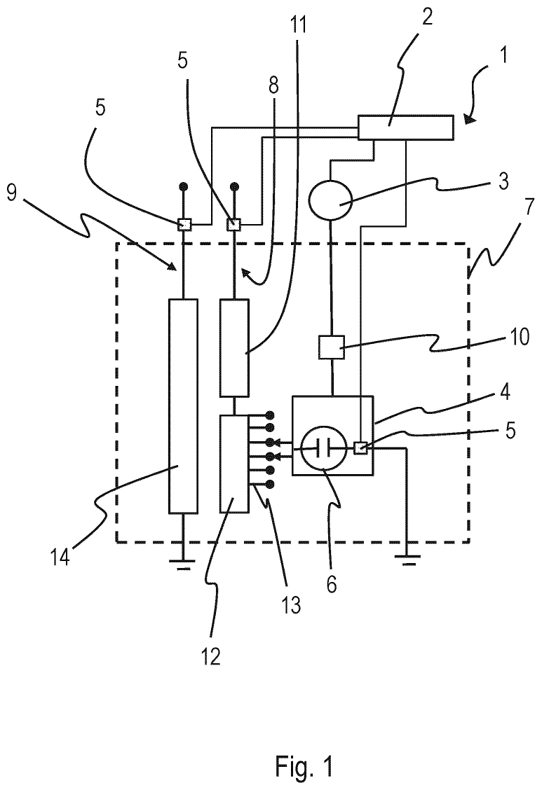

FIG. 1 shows an on-load tap-changer device 1. The on-load tap-changer device 1 comprises a control device 2, at least one sensor 5 and an on-load tap-changer 4. The control device 2 is connected to a drive 3 of the on-load tap-changer 4. The control device 2 is configured and designed to control the drive 3 so that the latter actuates the on-load tap-changer 4. Furthermore, the control device 2 is connected to a sensor 5 or a plurality of sensors 5 which measure(s) a current flowing through the tap-changing transformer 7, a vacuum interrupter 6 or else the on-load tap-changer 4. The control device 2 is designed and configured to detect, measure and evaluate the current detected by the sensor 5 or the sensors 5. In particular, the control device 2 determines the current profile, i.e. when the current has or assumes the value zero and at what frequency this happens. The sensor 5 may be arranged, for example, at the tap-changing transformer 7, in particular on the high-voltage side 8 or the low-voltage side 9. Furthermore, a sensor 5 can be arranged in the on-load tap-changer 4, directly on the vacuum interrupter 6 or at another arbitrary position which is suitable for detecting the profile of the current.

The control device 2 detects the current profile continuously before an actuation or else only when a switching command is received in the control device 2. For this purpose, the control unit 2 accordingly comprises a computing unit and/or a processor and/or a memory.

The drive 3 is mechanically connected, via a drive train 10, to the on-load tap-changer 4 and thus also to the vacuum interrupter 6. The drive is configured and designed to actuate the on-load tap-changer or to execute the switching command of the control unit.

The control device 2 can be arranged as a stand-alone device on the tap-changing transformer 7 or in a control room. Furthermore, the control device 2 may be a part of a drive controller of the on-load tap-changer 4 or formed as part of a voltage regulator. The control device 2 is designed and configured to control the drive 3.

The tap-changing transformer 7 has a main winding 11 and a tap winding 12. The on-load tap-changer 4 is connected to the tap winding 12 via the winding taps 13. The main winding 11 and the tap winding 12 are arranged on the high-voltage side 8 (in rare cases also on the low-voltage side). Furthermore, the tap-changing transformer 7 has a low-voltage winding 14 which is inductively coupled to the main winding 11 and the tap winding 12.

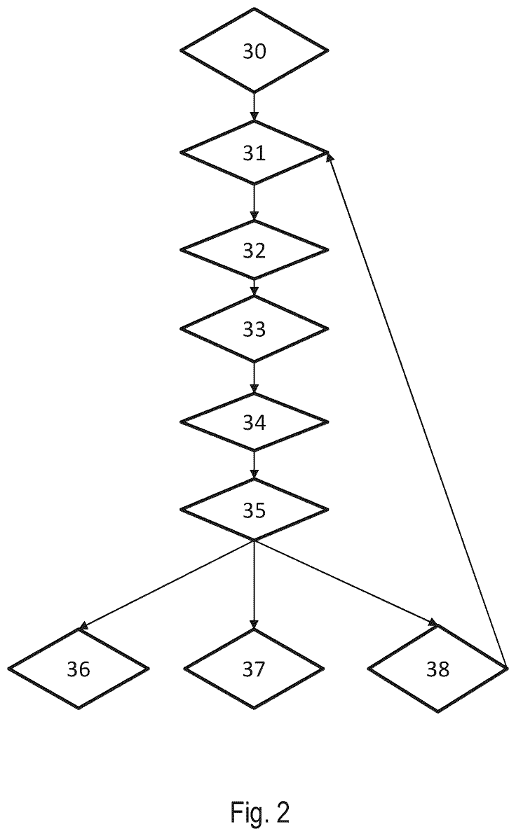

FIG. 2 shows a flowchart of a method for actuating an on-load tap-changer. In the context of the invention, “before actuation of an on-load tap-changer” means that irregular current profiles can be identified as early as before a switching command or even after a switching command. Before a switching command, the method is carried out continuously during operation. If an irregularity should already be detected here, the actuation is terminated immediately after the switching command or there is a pause for a predetermined time and the method is run through again until an actuation process can be carried out.

In a first step 30, the control device 2 receives a switching command at a starting time T0 for actuating the on-load tap-changer 4. The switching command may either be a manual switching command or it may also come from a voltage regulator.

In the next step 31, a current profile is detected via a sensor 5 and transmitted to the control device. The current profile can be detected both after the switching command and before the switching command.

In a next step 32, multiple consecutive times T1, T2, T3, Tx with current zero crossings of the current profile 20 are determined by the control device. In this case, either the newly detected current profile or the current profile before the switching command is used.

In a next step 33, the intervals A1, A2, Ax are determined based on the times T1, T2, T3, Tx of the current zero crossings.

In a next step 34, a characteristic value K is formed based on the intervals A1, A2, Ax.

In a next step 35, the determined characteristic value K is compared with a limit value G. If the characteristic value K satisfies or falls below the limit value G, the on-load tap-changer 4 is actually actuated in the next step 36. For this purpose, the control device 2 controls the drive 3 accordingly.

If the characteristic value K exceeds the limit value G, the actuation is terminated in a next step 37. As an alternative, if the limit value G is exceeded, in the next step 38, the actuation can be paused for a certain time and the method can be restarted.

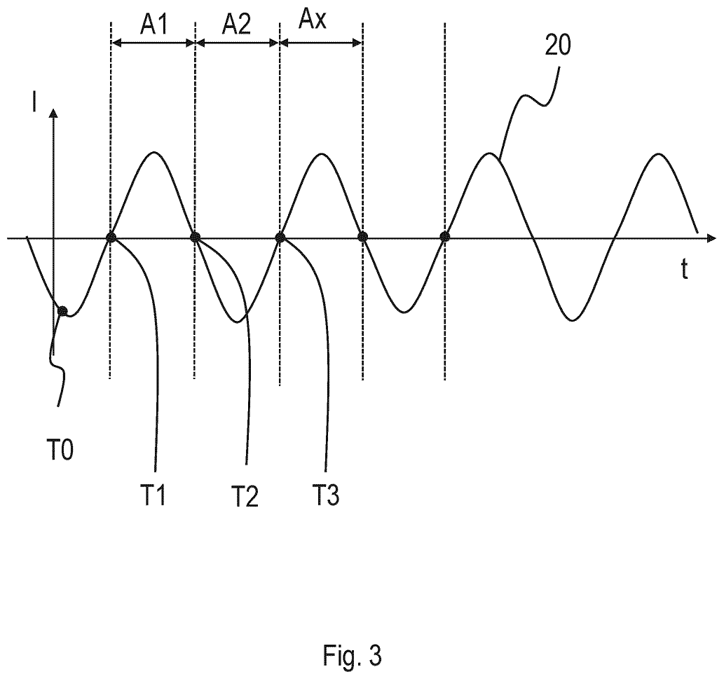

FIG. 3 is used to illustrate the method according to the invention. The temporal current profile t (in ms) within a tap-changing transformer is plotted on the X-axis. The Y-axis indicates the level of the current I in amperes. The profile of the current or the current profile is sinusoidal or approximately sinusoidal here. The curve of the current profile 20 intersects the X-axis at the current zero crossings. At these times T1, T2, T3, Tx, no current therefore flows through the tap-changing transformer and the vacuum interrupter 6 or the on-load tap-changer 4. At a starting time T0, a switching command to actuate or to begin the actuation of the on-load tap-changer 4 is received in the control unit 2.

This time is assumed to be the possible starting time T0 of a diverter switch operation. Proceeding from this starting time T0, at least three next times T1, T2 and T3 of the next current zero crossings are determined.

In the next step, the intervals A1 and A2 between the determined times T1, T2, T3 are determined. Specifically, the first interval A1 between the first and second time T1, T2 and the second interval A2 between the second and third time T2 and T3 are determined. The intervals A1 and A2 indicate how much time has elapsed between the times.

In a next step, a characteristic variable K is determined based on the segments A1, A2, Ax. For example, the segments A1 and A2, or all identified segments, can be put into a ratio with one another. Ideally, for example, A1 and A2 are the same size and the ratio is thus one. Once the characteristic variable K has been determined, it is compared with a limit value G. If the characteristic variable K exceeds the limit value G, the actuation is terminated or paused. Pausing means that the circuit is suspended for a defined time and then the method is carried out again. If the limit value is satisfied or undershot, the on-load tap-changer is actuated by means of the drive, which is controlled by the control device.

In the example shown here, the current profile is performed based on three times T1, T2, T3, i.e. three current zero crossings. However, it is also possible to use any number of current zero crossings T1-Tx as well as intervals A1-Ax for an evaluation. This depends on how long it is possible to wait for the actual actuation after a switching command. The manner in which a characteristic value K is determined and how the limit value G is defined can also be adjusted as needed.

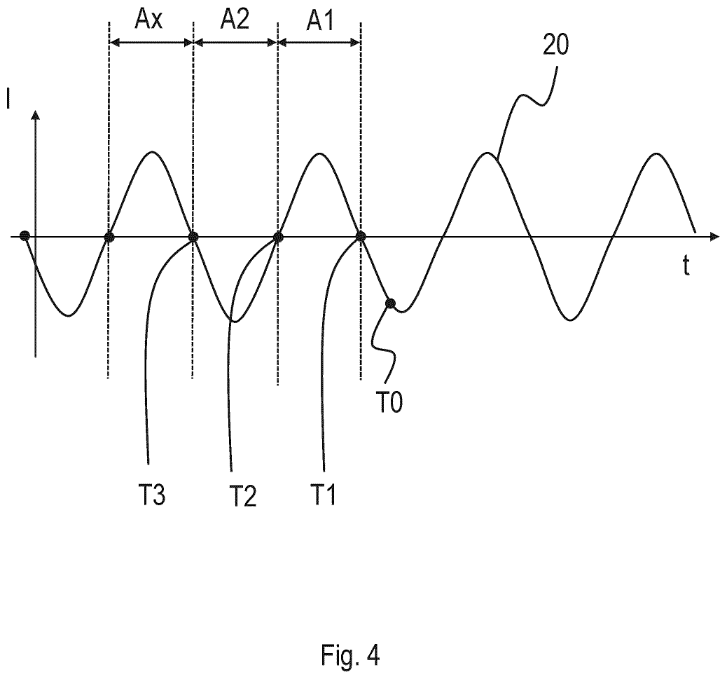

FIG. 4 is used to illustrate the method according to the invention according to a further embodiment. The temporal current profile t (in ms) within a tap-changing transformer is plotted on the X-axis. The Y-axis indicates the level of the current I in amperes. The profile of the current or the current profile is sinusoidal or approximately sinusoidal here. The curve of the current profile intersects the X-axis at the current zero crossings. At these times T1, T2, T3, Tx, no current therefore flows through the tap-changing transformer and the vacuum interrupter 6 or the on-load tap-changer 4. At a starting time T0, a switching command to actuate or to begin the actuation of the on-load tap-changer 4 is received in the control unit 2.

This time is assumed to be the starting time T0 of a diverter switch operation. Proceeding from this starting time T0, at least three times T1, T2 and T3 of the previous current zero crossings are determined, that is to say before the starting time T0. This is possible because the current profile was monitored and recorded before the switching command.

In the next step, the intervals A1 and A2 between the determined times T1, T2, T3 are determined. Specifically, the first interval A1 between the first and second time T1, T2 and the second interval A2 between the second and third time T2 and T3 are determined. The intervals A1 and A2 indicate how much time has elapsed between the times.

In a next step, a characteristic variable K is determined based on the segments A1, A2, Ax. For example, the segments A1 and A2, or all identified segments, can be put into a ratio with one another. Ideally, for example, A1 and A2 are the same size and the ratio is thus one. Once the characteristic variable K has been determined, it is compared with a limit value G. If the characteristic variable K exceeds the limit value G, the actuation is terminated or paused. Pausing means that the circuit is suspended for a defined time and then the method is carried out again. If the limit value is satisfied or undershot, the on-load tap-changer is actuated by means of the drive, which is controlled by the control device.

In the example shown here, the current profile is performed based on three times T1, T2, T3, i.e. three current zero crossings. However, it is also possible to use any number of current zero crossings T1-Tx as well as intervals A1-Ax for an evaluation. This depends on how long it is possible to wait for the actual actuation after a switching command. The manner in which a characteristic value K is determined and how the limit value G is defined can also be adjusted as needed.

The method therefore enables the current profile to be checked for irregularities as early as before a switching command and also immediately afterwards.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### Reference Signs

1 On-load tap-changer device
2 Control device
3 Drive
4 On-load tap-changer
5 Sensor
6 Vacuum interrupter
7 Tap-changing transformer
8 High-voltage side
9 Low-voltage side
10 Drive train
11 Main winding
12 Tap winding
13 Winding taps
14 Low-voltage winding
15 Further sensor
20 Current profile
T0 Starting time
T1 First zero crossing
T2 Second zero crossing
T3 Third zero crossing
Tx Further zero crossing
A1 First interval
A2 Second interval
Ax Further interval

1. A method for actuating an on-load tap-changer, the method comprising:
receiving, by a control device, a switching command for actuating the on-load tap-changer;
detecting, by a sensor, a current profile;
determining, by the control device, multiple consecutive times for current zero crossings of the current profile;
determining, by the control device, multiple intervals between the multiple consecutive times of the current zero crossings;
deriving by the control device, a characteristic variable from the multiple intervals;
comparing, by the control device, the characteristic variable with a limit value;
terminating or pausing, by the control device, the actuation based on determining that the characteristic variable exceeds the limit value;
performing the actuation based on determining that the characteristic variable satisfies or falls below the limit value by the control device controlling a drive.

2. The method as claimed in claim 1, wherein
the current profile is detected before or after the control device receives the switching command for actuating the on-load tap-changer.

3. The method as claimed in claim 1, further comprising:
determining the multiple consecutive times for current zero crossings of the current profile before a starting time of the switching command or after the starting time of the switching command.

4. The method as claimed in claim 1, wherein
the characteristic variable is formed from a ratio of at least two intervals.

5. The method as claimed in claim 1, wherein
the characteristic variable deviates from the limit value by a predetermined percent.

6. The method as claimed in claim 1, wherein the actuation is paused within a predetermined time after control device determines that the characteristic variable exceeds the limit value.

7. The method as claimed in claim 2, wherein
at least three consecutive times of the multiple consecutive times for current zero crossings of the current profile are determined before the starting time of the switching command or after the starting time of the switching command.

8. The method as claimed in claim 1, wherein
at least two intervals of the multiple intervals between the multiple consecutive times of the current zero crossings are determined by the control device.

9. An on-load tap-changer device comprising:
an on-load tap-changer;
a sensor;
a drive;
a control device;
wherein the control device is configured to:
receive a switching command to actuate the on-load tap-changer;
detect a current profile via the sensor;
determine multiple consecutive times for current zero crossings of the current profile;
determine multiple intervals between the times of the current zero crossings;
derive a characteristic variable from the multiple intervals;
compare the characteristic variable with a limit value;
terminate or pause the actuation by the control device based on determining that the characteristic variable exceeds the limit value;
actuate the on-load tap-changer by the drive based on determining that the characteristic variable satisfies or falls below the limit value.
